(19) United States
(12) Patent Application Publication
(10) Pub. No.: US 2018/0075216 A1
(43) Pub. Date: Mar. 15, 2018

(54) REAL-TIME UNIVERSAL MEDICATION MANAGEMENT DEVICE WITH LOCKING AND METERING, AND PROCESS FOR USING THE SAME

(71) Applicants: Lloyd Cleveland Nurse, Decatur, GA (US); Darien Okinza Nurse, Decatur, GA (US)

(72) Inventors: Lloyd Cleveland Nurse, Decatur, GA (US); Darien Okinza Nurse, Decatur, GA (US)

(21) Appl. No.: 15/705,163

(22) Filed: Sep. 14, 2017

Related U.S. Application Data
(60) Provisional application No. 62/394,263, filed on Sep. 14, 2016.

(51) Int. Cl. G06F 19/00; G08B 21/18; H04N 7/18; E05B 45/00

(52) U.S. Cl. CPC G06F 19/3462; G08B 21/18; E05B 47/00; E05B 45/00; H04N 7/188

(57) ABSTRACT

Devices, systems, and processes for real-time universal medication management with locking and metering are disclosed. Opening bottles and taking the right quantity of medicines presents a challenge to many. The devices, systems, and processes disclosed herein present solutions to this problem. Use of original dispensed containers has the advantage of being able to leverage uniquely identifiable Internet-of-Things (IoT) devices that may be efficiently connected and monitored by the professional healthcare industry. Managing all medicines and ingested materials simultaneously with vital sign recording provides new insights into patient care and pharmacogenomics. The disclosed devices, systems, and processes may provide a notification of when to take a dose of each medication, enabling teaching at the point of medicine access and recording actions to a personal account accessible via the Internet, thereby keeping users safely engaged throughout the medicine taking process.

### CROSS-REFERENCE TO RELATED APPLICATION

This application claims the benefit of U.S. Provisional Patent Application No. 62/394,263 filed Sep. 14, 2016. The subject matter of this earlier filed application is hereby incorporated by reference in its entirety.

### FIELD

The present invention generally pertains to medication management, and, more particularly, to devices, systems, and processes for real-time universal medication management with locking and metering.

### BACKGROUND

Medicine management problems and regulatory efforts to enhance safety and avoid these problems present a significant challenge to medical professionals, regulators, and patients. Various solutions have been proposed for adherence, but for the most part, these solutions have been fragmented and have not adequately met patient needs. Indeed, due to this fragmentation, substantial gaps in safety and accountability remain. In some cases, serious problems have arisen when the patient adheres to the wrong medicine. Patients may have different needs, and a solution that works for one patient may not work for another. Also, moving medicines out of prescription containers and into other containers (e.g., a pillbox) and the mixing of medicines hours before they are consumed may violate statutes of most jurisdictions and is generally prohibited in institutional care settings, unless repackaged properly by a pharmacist or another specially trained personnel. Nonetheless, this practice of mixing medicines is rampant in the industry.

Adherence and management should be handled simultaneously for all medicines in order to be most effective. For effective medicine management, the correct medicine should be determined and administered in the correct dose at the correct time. Real-time reporting of the effects of prescribed medications on a specific individual would assist medical professionals in quickly determining medicines with adverse effects, those causing allergic reactions, and those not working as expected while the patient is in or out of a care institution. For clinical studies and precision medicine, an Internet-of-Things (IoT) approach may be beneficial to apply. Accordingly, an improved solution may be beneficial.

### SUMMARY

Certain embodiments of the present invention may be implemented and provide solutions to the problems and needs in the art that have not yet been fully solved by conventional medication management devices, systems, and techniques. For example, some embodiments of the present invention pertain to devices, systems, and processes for real-time universal medication management with locking and metering and the recording of events in real-time, which generates useful data for timely intervention and analytics.

In an embodiment, a system includes a medication management device configured to store and dispense multiple medications. The medication management device includes memory storing computer program instructions that operate the medication management device and at least one processor configured to execute the computer program instructions and control operation of electronic components of the medication management device. The medication management device also includes a plurality of bins. Each of the plurality of bins is configured to store a respective medication. The medication management device further includes a metering mechanism for each of the plurality of bins. Each metering mechanism is configured to dispense a medication of the respective bin. Additionally, the medication management device includes a ramp or tube for each of the plurality of bins. Each ramp or tube is operably connected to a respective bin and configured to receive the dispensed medication from the respective bin. The medication management device also includes a dispenser base configured to receive the dispensed medication in a tray of the dispenser base, and/or to hold a cup that receives the dispensed medication.

In another embodiment, a medication management device includes a plurality of bins. Each of the plurality of bins configured to store a respective medication. The medication management device also includes a metering mechanism for each of the plurality of bins. Each metering mechanism is configured to dispense a medication of the respective bin. The medication management device further includes a ramp or tube for each of the plurality of bins. Each ramp or tube is operably connected to a respective bin and configured to receive the dispensed medication from the respective bin. Additionally, the medication management device includes a dispenser base configured to receive the dispensed medication in a tray of the dispenser base, and/or to hold a cup that receives the dispensed medication.

In yet another embodiment, a medication management device includes a plurality of bins. Each of the plurality of bins configured to store a respective medication. The medication management device also includes a metering mechanism for each of the plurality of bins. Each metering mechanism is configured to dispense a medication of the respective bin. The medication management device further includes a ramp or tube for each of the plurality of bins. Each ramp or tube is operably connected to a respective bin and configured to receive the dispensed medication from the respective bin. Additionally, the medication management device includes a dispenser base configured to receive the dispensed medication in a tray of the dispenser base, and/or to hold a cup that receives the dispensed medication, and a display configured to scan medications and provide medication information to the medication management device.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a system for providing real-time universal medication management with locking and metering, according to an embodiment of the present invention.

FIG. 2A is perspective view illustrating a medicine container with a QR code, according to an embodiment of the present invention.

FIG. 2B is perspective view illustrating a medicine container with a radio frequency ID (RFID) tag, according to an embodiment of the present invention.

FIG. 3 is an architectural diagram illustrating a medication management device, according to an embodiment of the present invention.

FIG. 4 is an architectural diagram illustrating a medication management device, according to an embodiment of the present invention.

FIG. 5 is a perspective view illustrating a wall-mounted medication management device, according to an embodiment of the present invention.

FIG. 6 is a perspective view illustrating a medication management device, according to an embodiment of the present invention.

FIG. 7A is a perspective view illustrating a portable medication management device, according to an embodiment of the present invention.

FIG. 7B is a side view illustrating the portable medication management device of FIG. 7A, according to an embodiment of the present invention.

FIG. 8A is a front cutaway view illustrating a medication management device, according to an embodiment of the present invention.

FIG. 8B is a front view illustrating the medication management device of FIG. 8A, according to an embodiment of the present invention.

FIG. 9 is a perspective view illustrating a standalone portable medication management device, according to an embodiment of the present invention.

FIG. 10 is a perspective view illustrating a “puck” portable medication management device, according to an embodiment of the present invention.

FIG. 11A illustrates a scanning screen on a tablet, according to an embodiment of the present invention.

FIG. 11B illustrates a container holder selection screen on the tablet, according to an embodiment of the present invention.

FIG. 12 is a flowchart illustrating a process for performing real-time universal medication management, according to an embodiment of the present invention.

FIG. 13 illustrates a computing system configured to control and/or interact with a medication management device, according to an embodiment of the present invention.

### DETAILED DESCRIPTION OF THE EMBODIMENTS

Some embodiments of the present invention pertain to devices, systems, and processes for real-time universal medication management with locking and metering and the recording of events in real-time, which generates useful data for timely intervention and analytics. In some embodiments, access to and use of medicine containers and their contents may be tracked as users go about their normal medicine-taking or caretaking routines. For instance, if the user is a patient, the user's typical interaction with the device may include picking up a medication container, taking the medicine, and putting the medication container back on/in the device. If the user is a caregiver, the user may be notified on his or her cell phone, for example, that it is time to administer one or more drugs to a patient. The user may then approach the system, retrieve the medicine (or medicines) to be administered, and administer them to the patient. In this manner, the user of the system may be dictated by the capabilities of the patient and their competency, and the system may be flexible enough to accommodate both patients and caregivers as users. For instance, patients with somewhat diminished but still capable mental capacity (e.g., early stages of Alzheimer's or dementia) may administer themselves their own medicine after receiving an alert. However, patients who are not reasonably capable of this on their own (e.g., later stage Alzheimer's patients, certain mentally challenged individuals, etc.) may need to have medicines administered to them. The system of some embodiments is capable of distinguishing one type of user from another.

The user may first be alerted as to when to pick up a certain medication container in some embodiments. The contents of the medication container may be displayed on a screen with any relevant information pertaining to the user, the origin of the medication, instructions for use, interactions and potential side effects to be monitored, and/or any other desired information without deviating from the scope of the invention. The text displayed on the screen may be large such that the elderly and individuals with visual impairments may more readily read the information. Additionally or alternatively, text may be presented in any language via a translation of the label text or electronic information stored on the container. The user may then be alerted to replace the medication container in its assigned location or be subjected to an amplified alert after a predetermined period of time has passed, if the user has not done so. If the user is a medical professional or caregiver, penalties may be assessed for noncompliance and incentives may be given for compliance. For instance, a small monetary incentive or penalty may be awarded for compliance on an individual instance basis, based on compliance over a period of time (e.g., a bonus), etc. Additionally, a user may be restricted to moving only one container at a time and may receive warnings from the system when the rules are violated or be subjected to a complete shutdown or lockout.

Some embodiments of the present invention simplify adherence and provide a collective advantage not provided by current approaches and systems including, but not limited to: (1) outlet power with battery backup; (2) operation both with or without an Internet connection (although being connected to the Internet may enable additional and/or enhanced functionality); (3) adjustable notification intensity in accordance with user preference; (4) ability to be used safely by the mentally and physically challenged; (5) preservation of medications in their original containers; (6) operability with multiple formats (e.g., pills, liquid containers, gel containers, boxes, etc.); (7) operability with multiple medicines and types simultaneously; (8) preset timing intervals for reduced setup time; (9) late notifications if users are late for a dose; (10) automatic adjustment to when the user actually takes a dose; (11) accounting for whether users take medication early or late; (12) reporting incorrect consumption to care providers; (13) initiating a call or message to a smart device if the alert persists for a predetermined period of time; (14) initiating an emergency response if no response is received for too long; (15) reporting untended adverse effects of prescribed medicines in real-time, enabling timely intervention; (16) showing medicine use alongside vital signs in real-time; (17) helping a user to catch pharmacy errors; (18) ensuring accurate and timely data collection and enhancing predictive science for clinicians and their patients; (19) helping to prevent a nurse or other medical professional from picking up the wrong medicine container and removing the need for frequent scanning and display interactions; (20) inclusion of electronic locking methods to prevent unauthorized access to medicines; (21) remote monitoring of step treatment that includes weaning a patient on and off of addictive and/or dangerous drugs; or any combination thereof.

Some embodiments of the invention prevent the container from being picked up in between dosing notifications via a mechanical or electronic locking mechanism that releases at the time of a dosing alert or when a specific user is identified. Certain embodiments alert consumers that it is time to take their medicine using light, sound, vibration, or any combination thereof. Some embodiments provide safe dosing intervals referenced from a selected initial start time and fixed spacing as decided by health care professionals. Certain embodiments start timing to the next dosing event when a medication container is actually replaced after being picked up to be taken. Picking up containers when there are no dosing alerts may be restricted/prevented via a locking mechanism and/or trigger an alarm. In some embodiments, picking up a container at any time is permitted depending on a user mode selected during setup. Some embodiments display usage details when a switch is pressed on or proximate to a specific container or compartment.

Some embodiments provide automatic metering of a single dose of medicine from the original containers in which the medication was dispensed. Certain embodiments maintain a lock on the medication container and dispense only a single dose to mitigate against patients taking too much or too little of their medication, or taking their medication at the wrong time. Some embodiments provide locking that restricts access to a single dose that only the intended user can access via coded locks.

Some embodiments compute and present total daily contents of vitamins, minerals, and other chemical content information of multiple medicines in use by an individual and organize that data for quick analysis by care providers by scanning a tag on a container. Certain embodiments alert an individual when there is a vitamin or mineral deficiency or the daily intake is dangerously over daily requirements. For instance, taking too much of an iron supplement can be fatal. Some embodiments allow users to add certain specific food and recreational items to their medication detail. For instance, the system may receive manual input of foods eaten or alcohol usage at the time of medication access. This may be useful for persons who may want to eat spinach once or twice a week when on coumadin so as to get the benefit of certain vitamins while monitoring and maintaining safe international normalized ratio (INR) levels, or allow persons to have a drink or two at a time that will not interfere with their medications. The system may learn to adjust dosing frequency or strength to allow the user a day of “indulgence” while keeping him or her safe. Automatic inputs may be received from vital sign metering devices to allow for the visualization of the effects of medicine or multiple medicines on a person's vitals.

Some embodiments provide feedback to healthcare professionals in real-time via interaction with a computer display to ensure early intervention, even when a medication is being taken as prescribed, but still creates problems. Certain embodiments enable online or offline access to medicine usage history and the history of other ingested items, such as foods, vitamins, alcohol, etc. Some embodiments enable research, auditing, and group or individual monitoring of new medicines by clinicians and other authorized entities or individuals.

Some embodiments have the advantage of making it easier for persons with progressively weakening mental and muscle functions to remain independent for an extended period of time. Certain embodiments allow persons with mental diseases to take critical medicines safely and accurately and be remotely monitored (e.g., with the use of cameras). Some embodiments permit doctors, pharmacists, and other medical professionals or caregivers to remotely adjust the metering of medicines to their patients. Certain embodiments visually record the actions of a consumer at the point of medicine access.

Some embodiments facilitate coordination with and management by pharmacies, manufacturers, and end users by having unique ID tags on each dispensing label or container. The objective of some embodiments is to recognize dispensing errors by displaying the color, shape, and size of medication in addition to performing facial recognition when a container is scanned into a computing device or when a user adds that item to his or her medicine detail. Some embodiments recognize and alert users to interactions between medicines (whether prescribed or over-the-counter) when added to the medicine detail. Certain embodiments provide consumers with an opportunity to learn their medication name, purpose, and expected side effects by seeing and hearing these details at the point of medicine access.

Some embodiments give consumers a chance to report their reason for stopping or starting their taking a medication in real-time. Certain embodiments permit responsible entities to globally recall medications by electronic means and/or to issue warnings to users of a medicine. Some embodiments empower individuals with control over their medicine use and other vital sign records for global portability.

Some embodiments prevent medicine prevent access by children or other individuals who are not supposed to access medication. Certain embodiments reduce confusion that can arise for persons taking multiple medicines. Some embodiments eliminate the risk of confusion and other errors when using pill boxes and transferring medicine from its original containers. Some embodiments reduce the workload on nurses and other care providers by having patients take their own medicines and sending a signal to a nurse or nursing station only when dosing alerts go unanswered or other irregularities occur (e.g., picking up a container before an alert, taking more medicine than recommended, or any other irregularities without deviating from the scope of the invention).

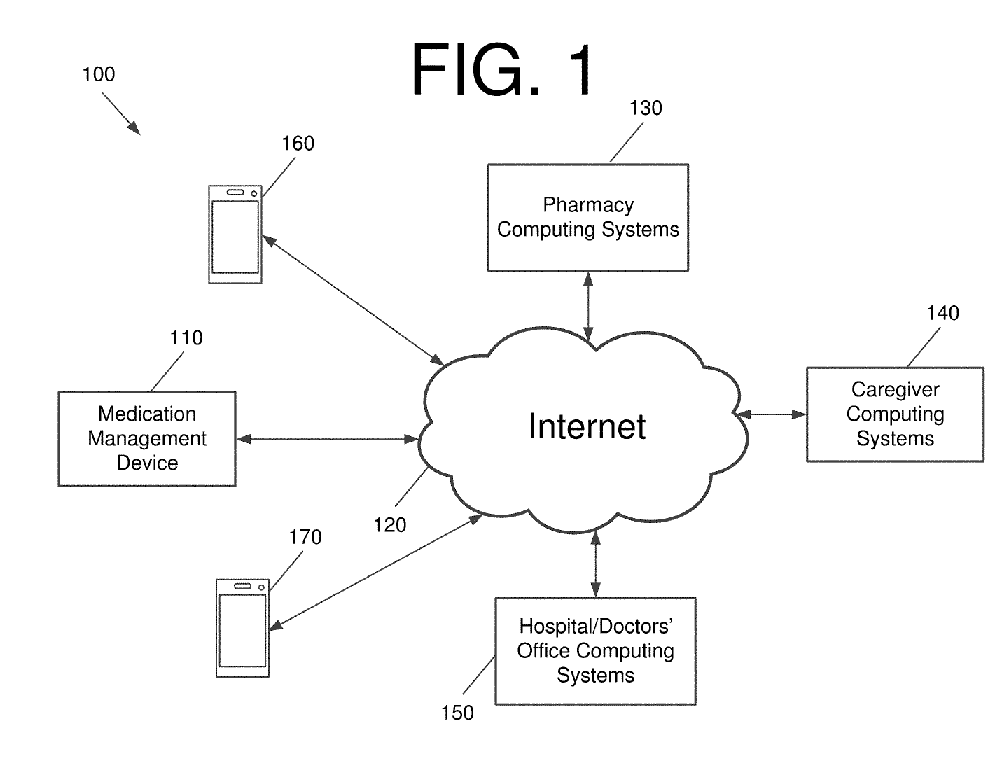

FIG. 1 illustrates a system 100 for providing real-time universal medication management with locking and metering, according to an embodiment of the present invention. System 100 includes a medication management device 110 that records and dispenses medication, locks medications in place, and provides alerts and alarms. Medication management device 110 is connected, via a wired or wireless connection to the Internet 120 to pharmacy computing systems 130 (e.g., pharmacy computers, servers, tablet computing devices, cell phones, etc.), caregiver computing systems 140 (e.g., caregiver computers, servers, tablet computing devices, cell phones, etc.), hospital and/or doctors' office computing systems 150 (e.g., hospital or doctors office computers, servers, tablet computing devices, cell phones, nursing station computers, etc.), and a mobile phone 160 (e.g., the cell phone of a family member, or any other desired electronic device, such as a tablet, laptop, desktop, etc.). Pharmacy computing systems 130, caregiver computing systems 140, hospital and/or doctors' office computing systems 150, and/or mobile phone 160 may be able to communicate between one another as well.

Pharmacy computing systems 130 may notify caregiver computing systems 140, hospital and/or doctors' office computing systems 150, or both, when medication is dispensed to a patient or an individual who is authorized to retrieve medication on behalf of the patient. Medication management device 110 may also be notified when medication is retrieved from the pharmacy, or retrieve the information from the scan of a label (text recognition, QR code, etc.) or sensing a tag or chip attached to the medication container. The information may include, but is not limited to, dosing schedule, side effects, active medication amount (e.g., 20 milligrams), interactions, drug name, recommended dosing times, whether to take with food, individual pill or dosage weight, or any other desired information without deviating from the scope of the invention. The user or caregiver may then place the medication container on or in medication management device 110 and lock it using a locking mechanism (not shown).

Once one or more medications are loaded, medication management device 110 monitors user medication adherence. The user may be required to begin taking the medication immediately or at a desired starting time (e.g., 5 minutes from loading medication, 1 hour after loading medication, beginning at 6:00 pm, etc.). Medication management device 110 then alerts the user that it is time to take the medication using lights, sound (e.g., a beep, a chime, a spoken indication that may call to the user by name and also name the medication), vibration, or any combination thereof. Specific alerts, alert patterns, a combination thereof may be provided for different medications. For instance, the flashing color, pattern, and/or intensity of the light, the pattern of the vibration, the volume and/or type of the chime, or any combination thereof may be different from one medication to another. Additionally or alternatively, an alert may be sent to the user's mobile phone 170 (or any other desired electronic device, such as a tablet, laptop, desktop, etc.). The user may be able to respond to the alert on mobile phone 170, which may stop the alert for a predetermined time to allow the user to take the medication (e.g., 5 minutes, 10 minutes, etc.). If the user is not near the medication, the user may communicate with pharmacy computing systems 130, caregiver computing systems 140, hospital and/or doctors' office computing systems 150, mobile phone 160, or any combination thereof, to let them know their current location and reason that they cannot currently take the medication.

If the alert persists for a predetermined period of time, pharmacy computing systems 130, caregiver computing systems 140, hospital and/or doctors' office computing systems 150, mobile phone 160, or any combination thereof, may be notified to attempt to contact the user. If the user cannot be reached, either a predetermined amount of time after this notification or at the behest of the medical professional or caregiver, emergency personnel (such as the EMS) may be notified to respond to the user's location.

In order to take the medication, in some embodiments, medication management device 110 may unlock the medication container, which the user can then pickup and replace. This may also stop the alert for a predetermined period of time. Medication management device 110 may sense that the medication has been picked up using a light-based sensor, a scale, or any other suitable mechanism without deviating from the scope of the invention. The user then replaces the container in the appropriate location on/in mediation management device 110.

In some embodiments, the scale of medication management device 110 is sensitive enough that it can detect and confirm whether the weight has been reduced by an amount that corresponds with the dosage. If no medication has been removed or too much medication has been removed, an alert may be sent to pharmacy computing systems 130, caregiver computing systems 140, hospital and/or doctors' office computing systems 150, mobile phone 160, or any combination thereof. In certain embodiments, a camera (not shown) is included as part of medication management device 110, either incorporated therein or separately mounted and incorporated via wired or wireless communication. The camera may begin recording when the user removes the medication container and stop recording when the user returns the medication container to medication management device 110, when a hand is moved to the mouth if video recognition software is included that enables recognizing such a gesture, a predetermined amount of time thereafter, or any other suitable time without deviating from the scope of the invention. In some embodiments, it is important to continue recording after the person replaces the container since this action may occur before the user takes the medication. An alert including the video may be provided to caregiver computing systems 140, cell phone 160, or both, when the medication container is returned to the medication management device 110.

Alternatively, rather than allowing the user to pick up medication containers, medication management device 110 may meter out a dose from the container, or the contents of the container may be loaded into a respective dispenser. The dose may be dispensed to a tray that may have a scale. When the user takes the medication, the user may press a button, press the tray down, etc., or the scale may sense that the dosage has been retrieved.

Once the medication container is returned to medication management device, the period until (if there are more doses to take). The timer may then be reset for that medication, and medication management device 110 will provide the next alert when it is again time to take the medication (or time to take another medication). The timer may be reset in accordance with when the user actually took the medication or may stay on the fixed interval (e.g., every six hours), depending on what is best for that respective medication. In some embodiments, medication management device 110 may provide an alert to pharmacy computing systems 130, caregiver computing systems 140, hospital and/or doctors' office computing systems 150, mobile phone 160, or any combination thereof, when a predetermined number of doses remain, or when all doses have been taken.

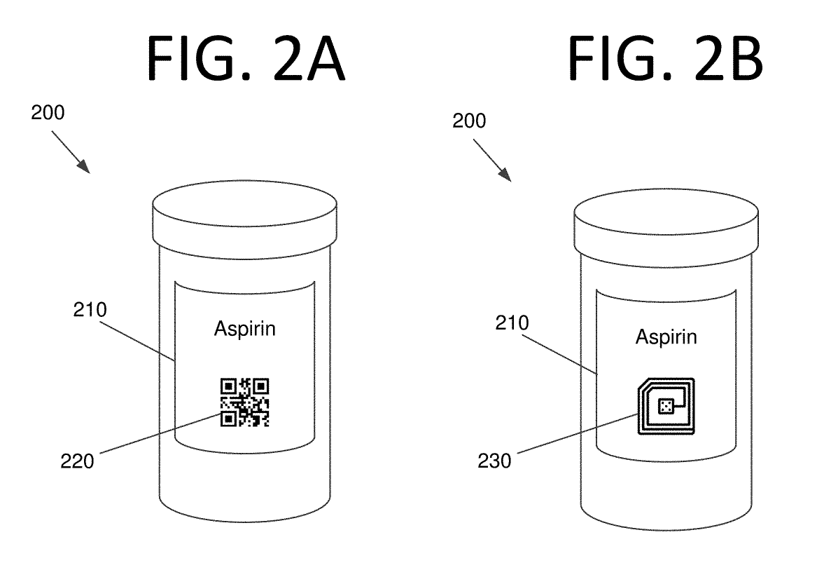

A primary goal of some embodiments is to track medicine from the manufacturer through distribution channels, such as pharmacies and clinics, to the individual end user. Unique identifiers, such as QR codes on regulation labels r affixed RFID tags, makes this possible in some embodiments. For instance, medication container 200 in FIGS. 2A and 2B includes a QR code 220 on a label 210 or an RFID tag 230, respectively. It should be noted that QR code 220 and/or RFID tag 230 may be located at any desired location of medication container 200 without deviating from the scope of the invention. The unique identifiers may be provided by the pharmacist, and may provide the basis for tracking and logging the movement of the medication container and its contents after distribution. If the medication container is not placed within, and detected by, a medication management device within a predetermined time after dispensing, an alert may be generated to the appropriate parties (e.g., the pharmacist, caregiver, the authorities, etc.). The medication management device, pharmacy computing systems, etc., such as those shown in FIG. 1, may extend control over controlled substances by the Food and Drug Administration (FDA) and the authorities beyond what is currently available. Such features may help in fighting the current opioid crisis.

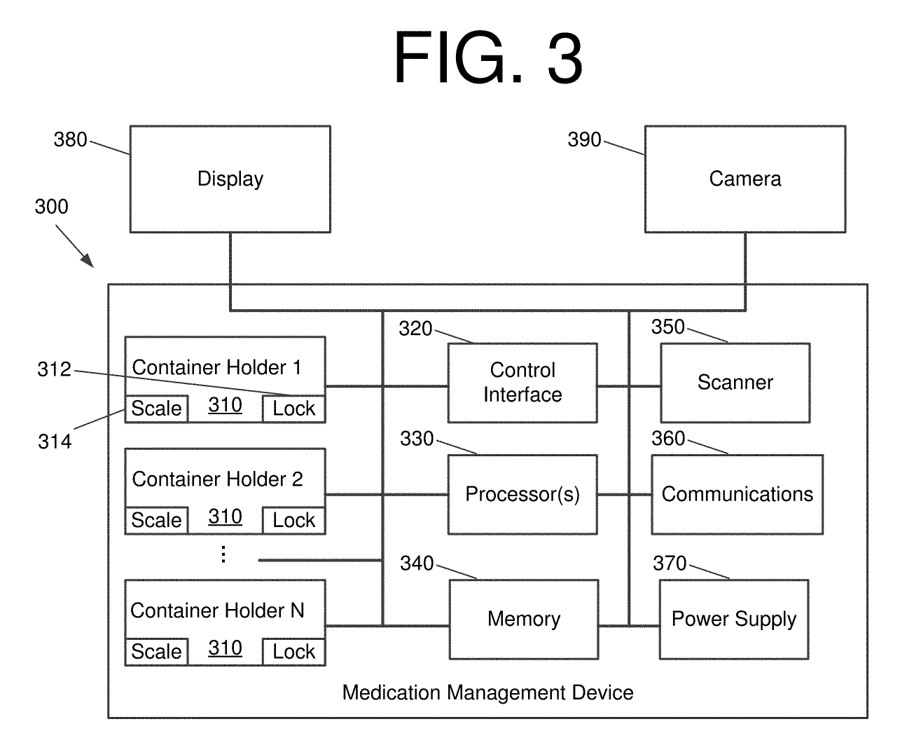

FIG. 3 is an architectural diagram illustrating a medication management device 300, according to an embodiment of the present invention. Medication management device 300 includes N container holders 310 that each hold a respective medication container. Container holders 310 may be provided in multiple different shapes and sizes that accommodate different medication container shapes/sizes. Each container holder 310 in this embodiment includes a lock 312 that locks a respective medication container in place and an electronic scale 314 that measures the weight of the medication container and its contents housed within. However, in some embodiments, more than one container holder 310, or all container holders 310, may share a common scale.

A control interface 320, such as a keyboard, a haptic interface, buttons, or any combination thereof, allow the user to interact with medication management device 300. Processor(s) 330 (e.g., microcontroller(s), processor(s), field programmable gate arrays (FPGAs), etc., or any combination thereof) and memory 340 (e.g., hard drive memory, RAM, solid state memory, external storage, removable storage, or any combination thereof) control the operation of medication management device 300 and by storing and executing computer program code. A database of medications and their properties, as well as container information, may be stored in memory 340 or accessed externally via communications 360 (e.g., a transceiver, a network card, etc.).

Scanner 350 allows the user to scan the label of the medication container, a code thereon, and/or an RFID tag to determine the type of medication, medication properties, and container properties. Alternatively, if RFID tags are used, medication management device 300 may determine the medication properties by communicating with the RFID tag (which may be active or passive). A power supply 370 (e.g., an outlet power supply, batteries, or both) supplies power to medication management device 300.

In this embodiment, an external display 380 and camera 390 are included. However, in some embodiments, one or both of these components are included within the medication management device itself. Display 380 (e.g., a monitor, a television, a tablet computer, etc.) may be wall-mounted and may provide information to the user in a larger format than would otherwise be possible. Camera 390 allows external medical professionals and caregivers to view the user's interactions with medication management device 300. In certain embodiments, medication management device 300 may be controlled by a smart phone application and/or a computer application.

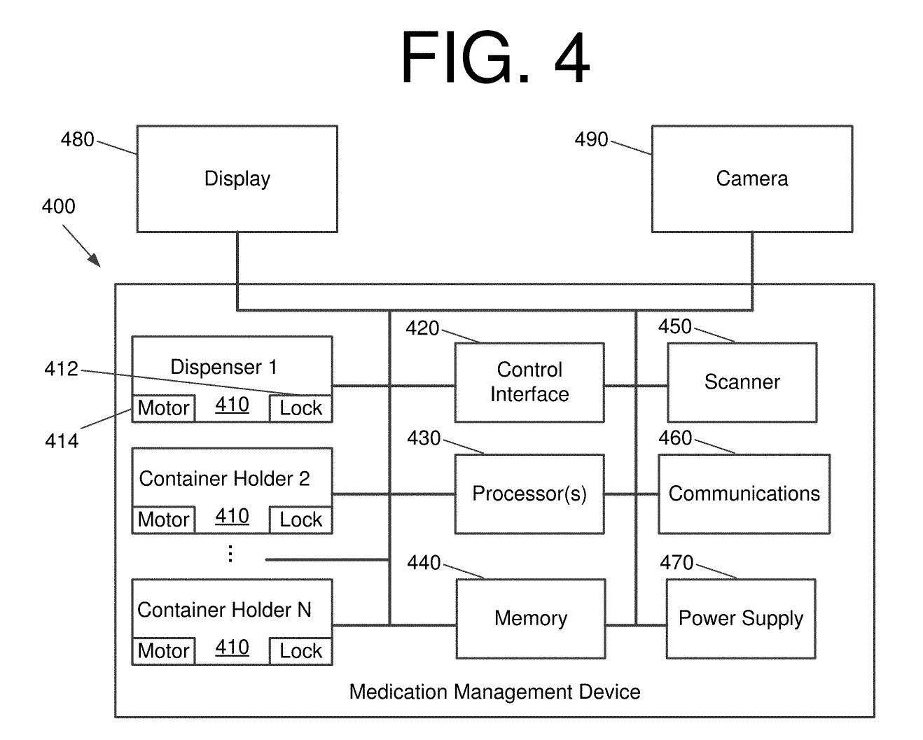

FIG. 4 is an architectural diagram illustrating a medication management device 400, according to an embodiment of the present invention. Similar to medication management device 300 of FIG. 3, medication management device 400 includes a control interface 420, processor(s) 430, memory 440, a scanner 450, communications 460, a power supply 470, a display 480, and a camera 490. However, in this impediment, in lieu of container holders, dispensers 410 are used to hold and dispense medication. Each dispenser has a lock 412 that prevents access to the medication. A motor 414 with a metering mechanism (not shown) dispenses the correct number of pills or amount of liquid when it is time to take the medication.

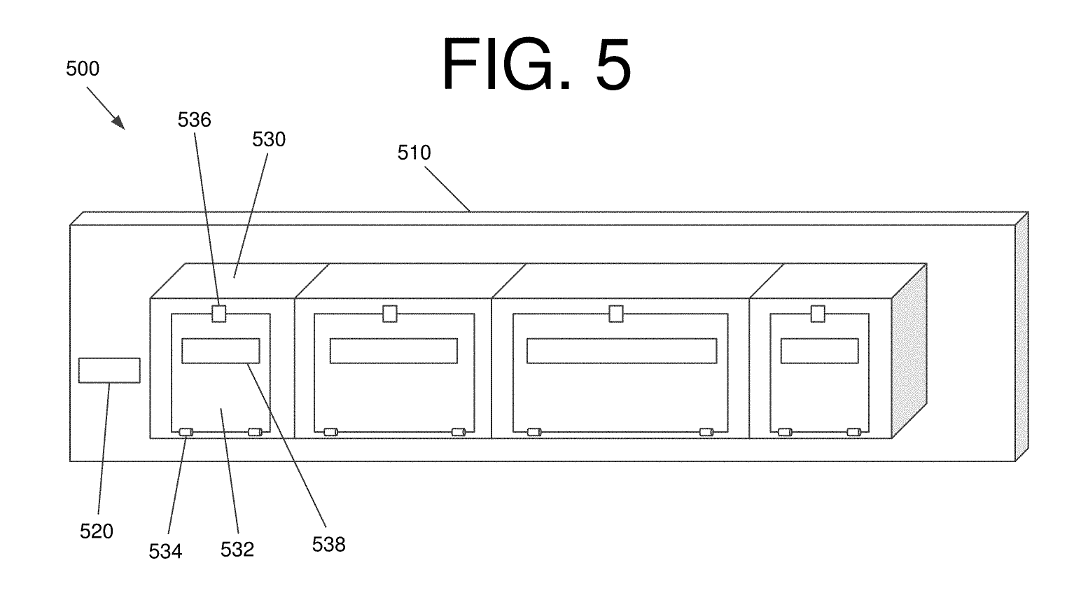

FIG. 5 is a perspective view illustrating a wall-mounted medication management device 500, according to an embodiment of the present invention. In this embodiment, housing 510 stores the electronic components of medication management device 500, which may be similar to those shown in FIGS. 3 and 4. Housing 510 may be mounted to a wall via fasteners, hooks, hangars, adhesives, or any other suitable mounting mechanism without deviating from the scope of the invention. A scanner 520 enables users to scan medication containers, and then place them in a respective container holder 530 (here, shown with box shape, but any suitable shape and configuration may be used without deviating from the scope of the invention). Container holders 530 have different sizes in this embodiment, and all have a door 532, hinges 534 that enable door 532 to open, a lock 536 with a corresponding sensor (not shown), and a viewing window 538.

Doors 532 may be unlocked when no medication is stored inside their respective container holder 530. After scanning the medication container using scanner 520, the user may select an empty container holder 530, place the medication inside, and shut respective door 532. Lock 536 then locks the container inside. In some embodiments, indicator lights (not shown) may be included that provide visible alerts to the user when it is time to take a medication. The indicator lights may also provide an indication that it is not time to take a medication (e.g., one or more indicator lights glowing green).

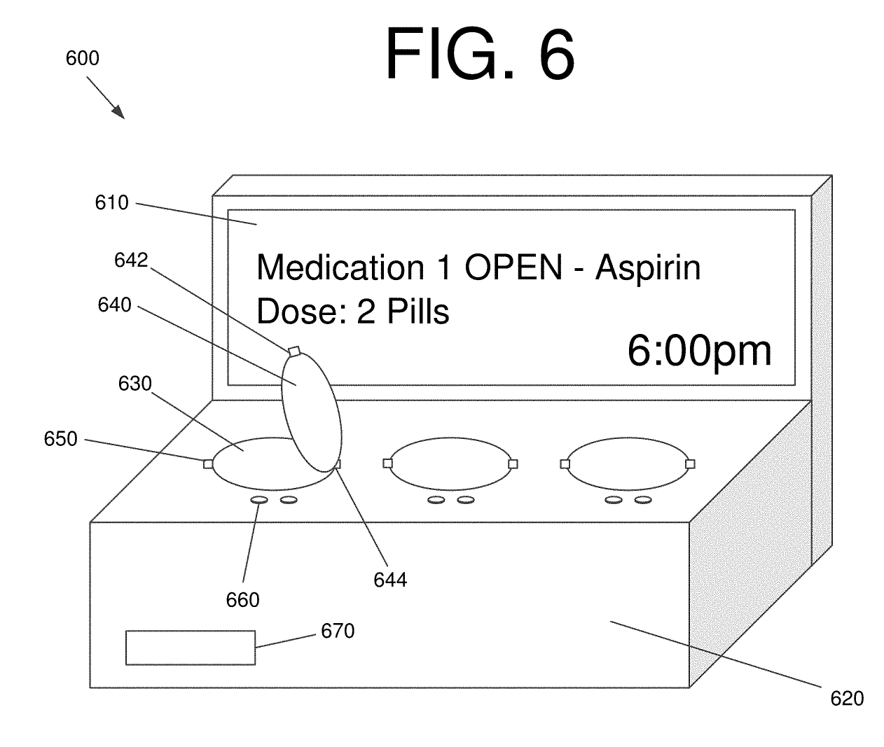

FIG. 6 is a perspective view illustrating a medication management device 600, according to an embodiment of the present invention. Medication management device 600 may have many of the components and much of the functionality of medication management devices 300, 400, 500 of FIGS. 3-5. Medication management device 600 includes a display 610 that displays various information to the user and a medication housing 620 that stores medications. Medication housing 620 includes three container holders 630, which in this embodiment are recesses within medication housing 620. Any desired number, shape, size, and arrangement of container housings may be used without deviating from the scope of the invention.

Each container holder 630 includes a cover 640 with a latch 642 and a hinge 644. Latch 642 engages with a lock 650 that allows cover 640 to close and lock, and then unlock and open when it is time to take a medication. Indicator lights 660 indicate the status of the respective medication container in respective container housing 630. To load a medication, scanner 670 may be used in a similar manner to scanner 520 of FIG. 5.

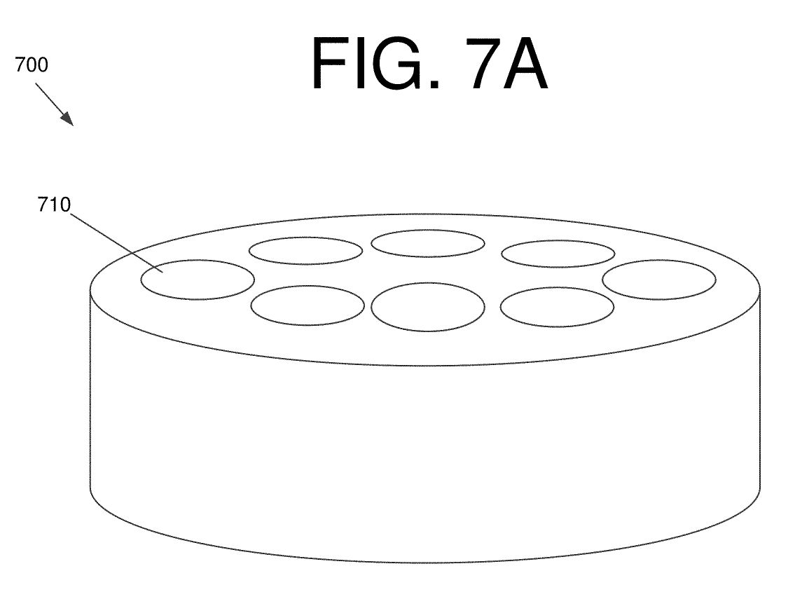

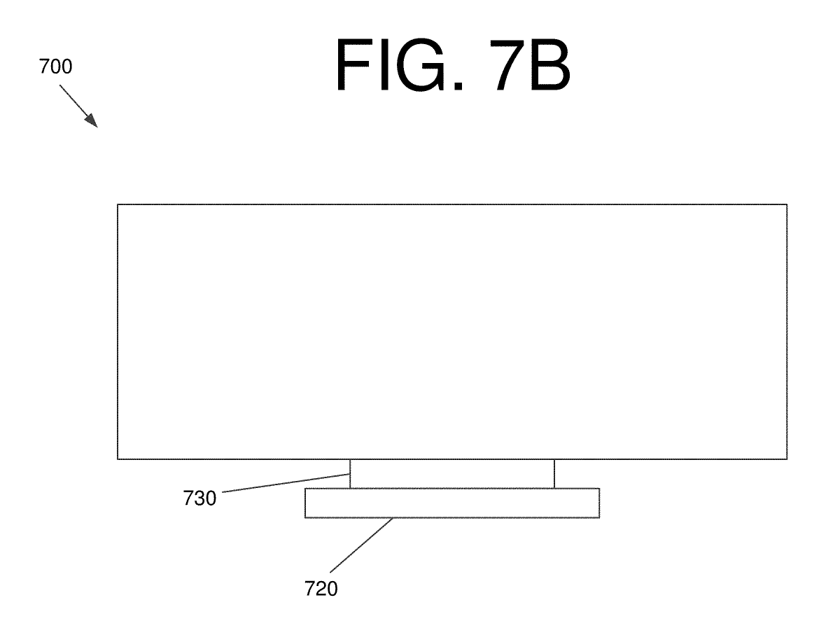

In certain embodiments, the medication management device may be portable. Such a configuration is shown in portable medication management device 700 of FIGS. 7A and 7B. Medication management device 700 includes multiple container holders 710, and may have many of the components and much of the functionality of medication management devices 300, 400, 500, 600 of FIGS. 3-6. In this embodiment, medication management device 700 includes a base 720 and a swivel member 730 that enables medication management device 700 to be rotated.

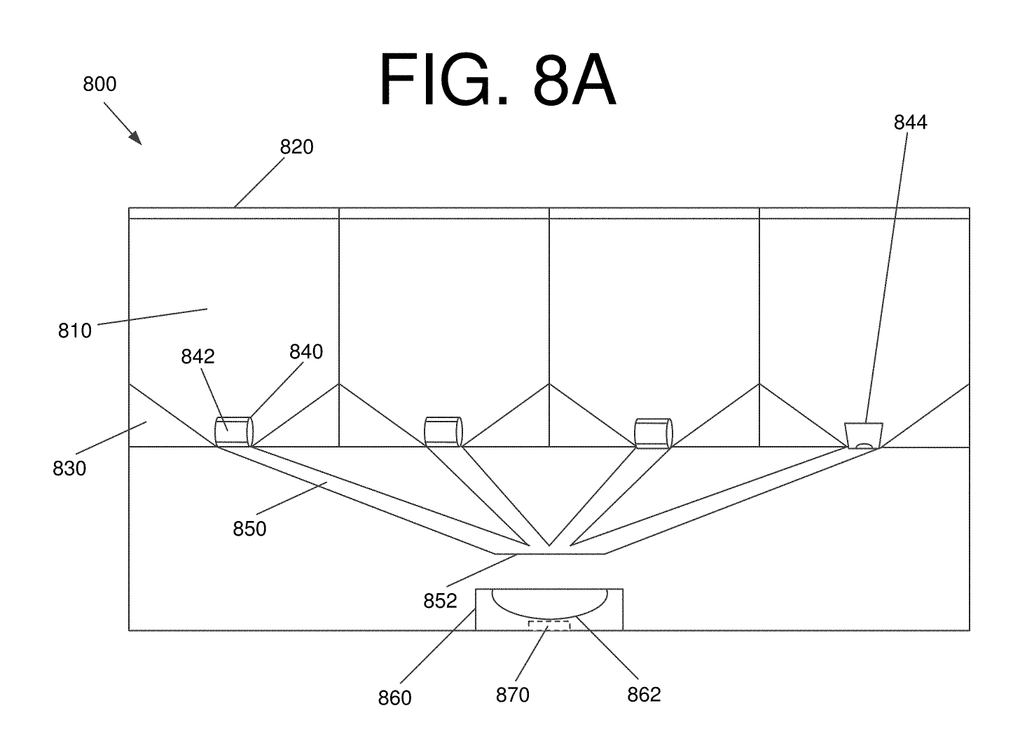

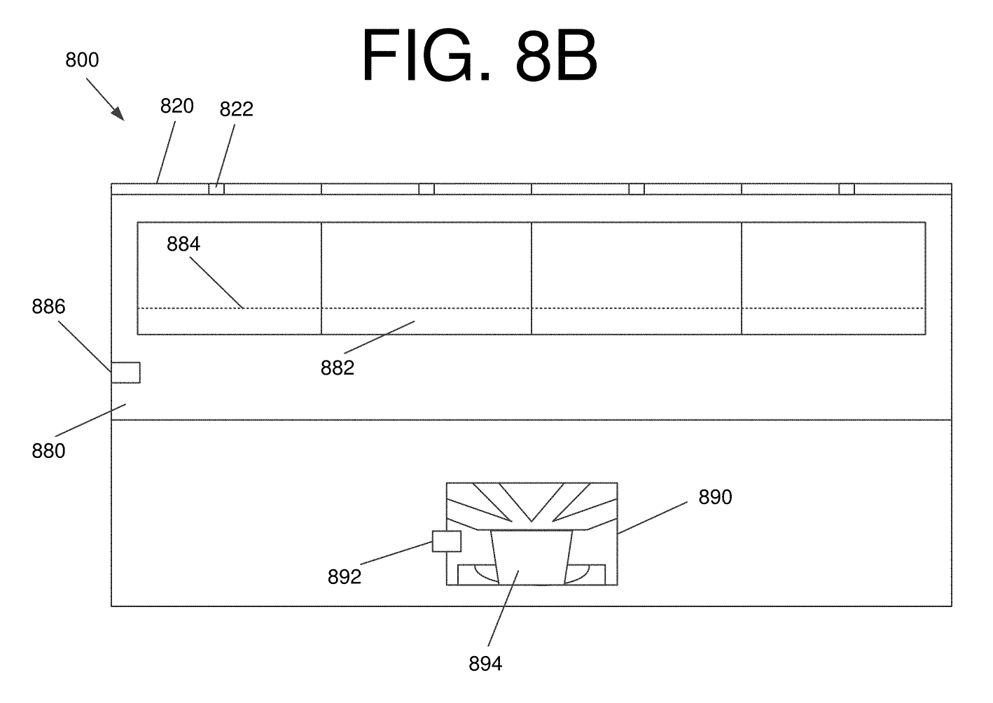

FIG. 8A is a front cutaway view illustrating a medication management device 800, according to an embodiment of the present invention. Medication management device 800 may have many of the components and much of the functionality of medication management devices 300, 400 of FIGS. 3 and 4, for instance. Medication management device 800 includes bins 810 that each store separate medications. Each bin 810 includes a locking lid 820 that may be locked after medication is added via an automatic or manual lock (not shown). Additionally or alternatively, all bins 810 may be locked in a single cabinet door (see FIG. 8B) on the front of medication management device 800. Ramps and/or tubes 830 define an opening through which pills and/or liquid can pass via an electronically controlled drum 840.

Motorized drum 840 has recesses 842 that are sized so as to accommodate only one pill, or a desired amount of liquid. Drum 840 is rotated so as to dispense one pill or one dose of liquid, which slides down a ramp 850 and into a dispenser base 860 via a lip 852. Pills and/or liquid collect in a tray 862 of dispenser base 860. However, in some embodiments, dispenser base 860 does not have a tray. Indeed, dispenser base 860 may be any suitable shape and/or size without deviating from the scope of the invention. A cup (see FIG. 8B) may alternatively be placed under lip 852 to collect medications.

An internal scale 870 may be used to verify that the correct dosage has been dispensed. For instance, motorized drum 840 may be rotated such that one recess rotates past the opening. If no pill is detected, this process may be repeated until a pill is detected by scale 870. Once the pill is detected, a pill counter may be decremented in software. In some embodiments, pills and/or liquid may be dispensed into a cup (not shown) rather than directly into tray 862. In certain embodiments, medication management device 800 may dispense liquid in at least one of bins 810 rather than pills alone. The same or a similar metering mechanism may be employed. Alternatively, an electronically controlled valve 844 may be employed to meter out the appropriate amount of liquid.

Medication management device 800 may offer a proactive user mode and/or a reactive user mode. A proactive user may access medicine with or without alerts by interacting directly with the display. It is not necessary to touch the display to take medicines. On the other hand, a reactive user waits for an alert before taking medicine. This may be a particularly beneficial configuration for patients with mild dementia, for example, since they cannot be relied upon to remember longer than a short period of time.

FIG. 8B is a front view illustrating medication management device 800, according to an embodiment of the present invention. In this view, electronically controlled locks 822 for locking lids are visible. For instance, in some embodiments, locks 822 may be magnetic locks or mechanical locks. As can be seen, medication management device 800 has a cabinet-like configuration with a medication access door 880 extending along an upper portion thereof. Door 880 may be used to access all medications at once. Door 880 includes a window 882 that allows viewing of the medication remaining in bins 810. A plastic, glass, or plexiglass clear wall 884 (or a solid or opaque wall) keeps solid and liquid medications in place. A lock 886, which may be similar to lock 822, locks/unlocks door 880.

On its lower portion, medication management device 800 includes a clear dose access door 890 (which would be opaque or solid in some embodiments) that locks via lock 892, which may be similar to lock 822 as well. A cup 894 resides under lip 852 and catches dispensed medications in this embodiment. Once scale 870 detects that the correct weight of medicine (or medicines) has been issued, medication management device 800 may unlock lock 892. If too little medication is dispensed, medication management device 800 may attempt to meter the medication again. If after multiple attempts, the medication cannot be metered out, or if too much medication is metered, medication management device 800 may issue an alarm to appropriate personnel and/or devices indicating that an error occurred and requesting action. If a medication runs out, medication management device may issue an alert to appropriate personnel and/or devices indicating that this is the case. Generally, the medication counter will reorder medicine before it is depleted. Also, if medication management device 800 determines that a lock has been forced open that should not have been, medication management device may issue an alarm to appropriate personnel and/or devices informing them of the issue.

It should be noted that while picking up a container can signal medication access in some embodiments, opening a compartment door or releasing a lock may indicate the same action in certain embodiments. Any response that can signal an interaction with a specific location may be used as confirmation of usage without deviating from the scope of the invention. In some embodiments, the user may be asked to further confirm usage of medication by interaction with the display. The dexterity of the user may determine which method or process is utilized. Flexibility in time to access medication is also a function of the urgency of accuracy and can be adjusted. In some embodiments, a user may be permitted to take a dose of medicine before the alert if the user needs to leave home prior to the dosing time. The system may be configured to automatically adjust and keep the user safe via the associated display. Biometric locking may be performed by external access to internal electronics, locking mechanisms, the display, or keyless entry via an active or passive RFID tag, for instance.

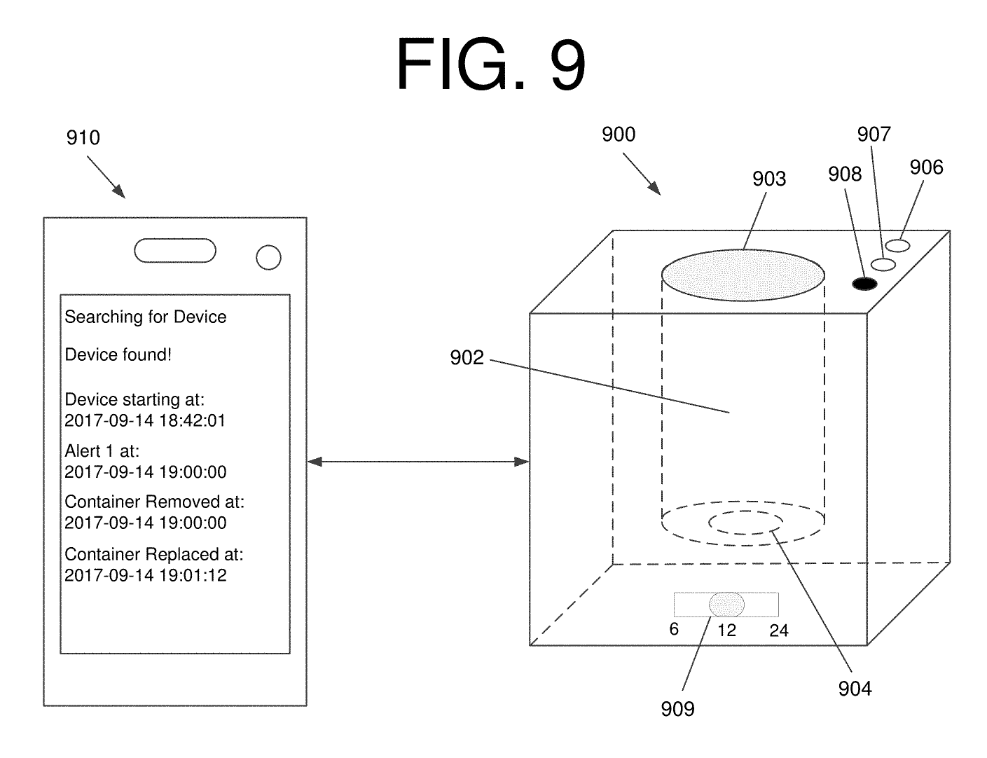

FIG. 9 is a perspective view illustrating a standalone portable medication management device 900, according to an embodiment of the present invention. Portable medication management device 900 can be carried by the user while traveling, and may be used at any desired location. Device 900 is cube-shaped in this embodiment, but may have any desired shape without deviating from the scope of the invention. Device 900 may include similar internal components to at least some of this shown in medication management devices 300 and 400 of FIGS. 3 and 4 in some embodiments.

Device 900 includes a container receptacle 902 with an opening 903 into which pill containers can be inserted. Container receptacle 902 may also have any desired shape without deviating from the scope of the invention. A sensing plate 904 senses when a medicine container has been placed in or removed from device 900. Device 900 also includes an indicator light 906 that indicates a status of device 900. Device 900 also includes a speaker 907 that provides audible alerts, and may include an oscillating motor (not shown) that provides vibrating alerts. Device 900 may be turned on and off via on/off button 908.

In this embodiment, device 900 includes a dosage timing switch 909 that allows the user to select the dosage time for a specific medicine. However, in other embodiments, device 900 may have a hard-coded dosage time (e.g., 3 hours, 6 hours, 12 hours, 24 hours, etc.). In certain embodiments, the dosage timing may be set via a software application running on mobile device 910 (e.g., a cell phone, tablet, laptop computer, etc.).

Device 900 has internal communications hardware (not shown) and is configured to communicate with mobile device 910. For instance, in some embodiments, device 900 may be Bluetooth™-enabled and may pair with mobile device 910 via a software application running thereon. In this embodiment, the software application of mobile device 910 detects and pairs with device 900, and provides various status indicators to the user. Once the user turns on device 900 and places a medication container therein, a notification is provided on mobile device 910 and a timer is started. At the time of the first alert (i.e., time to take the first dose), the application notifies the user and device 900 also issues an alert. The user then removes the medication container, takes the medication, and replaces the medication container in container receptacle 902. Appropriate status messages are displayed on mobile device 910 via the application, and the timer is restarted. More advanced features may be provided in certain embodiments, such a sensing whether medication was taken and how much was taken, alerting medical professionals, caregivers, and/or family members, etc. In some embodiments, a simpler version of device 900 may be provided that does not communicate with a mobile device.

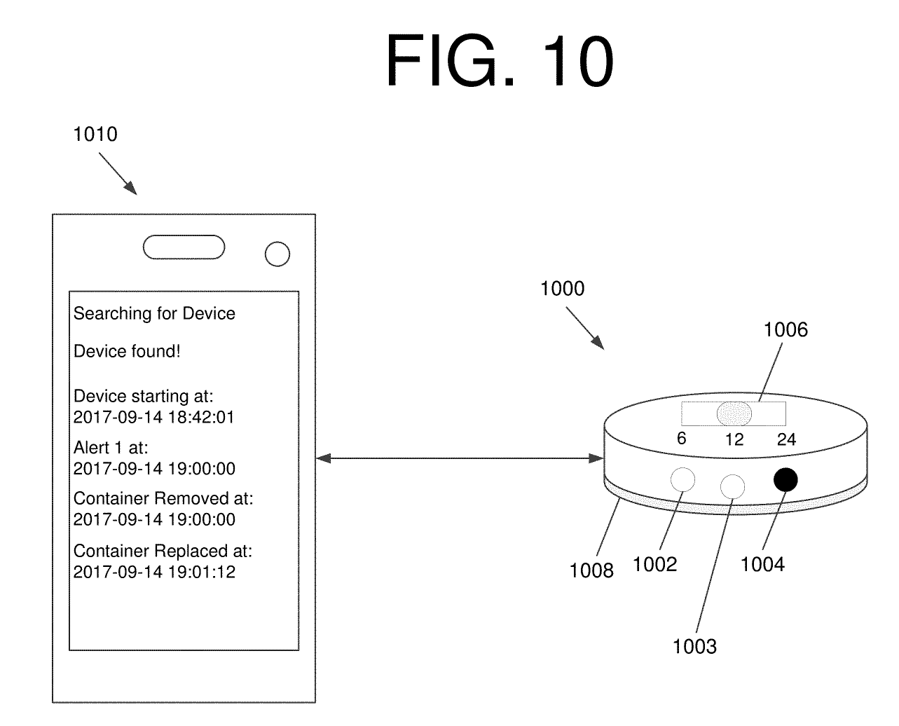

FIG. 10 is a perspective view illustrating a “puck” portable medication management device 1000, according to an embodiment of the present invention. Puck 1000 is even more readily portable than device 900 of FIG. 9, and can go wherever the respective medication container goes. Puck 1000 may include similar internal components to at least some of this shown in medication management devices 300 and 400 of FIGS. 3 and 4 in some embodiments. Puck 1000 has a flattened cylinder shape in this embodiment, but may have any desired shape without deviating from the scope of the invention.

Puck 1000 includes an indicator light 1002 that indicates a status of puck 1000. Puck 1000 also includes a speaker 1003 that provides audible alerts. Puck 1000 may be turned on via button 1004, which can also be used to acknowledge alerts. In this embodiment, puck 1000 turns off after a predetermined period of time. However, in other embodiments, a separate on/off switch may be provided.

In this embodiment, puck 1000 includes a dosage timing switch 1006 that allows the user to select the dosage time for a specific medicine. However, in other embodiments, puck 1000 may have a hard-coded dosage time (e.g., 3 hours, 6 hours, 12 hours, 24 hours, etc.). In certain embodiments, the dosage timing may be set via a software application running on mobile device 1010 (e.g., a cell phone, tablet, laptop computer, etc.). An adhesive 1008 allows the user to affix puck 1000 to a medication container.

Puck 1000 has internal communications hardware (not shown) and is configured to communicate with mobile device 1010. For instance, in some embodiments, puck 1000 may be Bluetooth™-enabled and may pair with mobile device 1010 via a software application running thereon. In this embodiment, the software application of mobile device 1010 detects and pairs with puck 1000, and provides various status indicators to the user. Once the user turns on puck 1000 and places a medication container therein, a notification is provided on mobile device 1010 and a timer is started. At the time of the first alert (i.e., time to take the first dose), the application notifies the user and puck 1000 also issues an alert. The user then takes the medication and presses button 1004, indicating that the medication was taken. Appropriate status messages are displayed on mobile device 1010 via the application, and the timer is restarted. In some embodiments, a simpler version of puck 1000 may be provided that does not communicate with a mobile device.

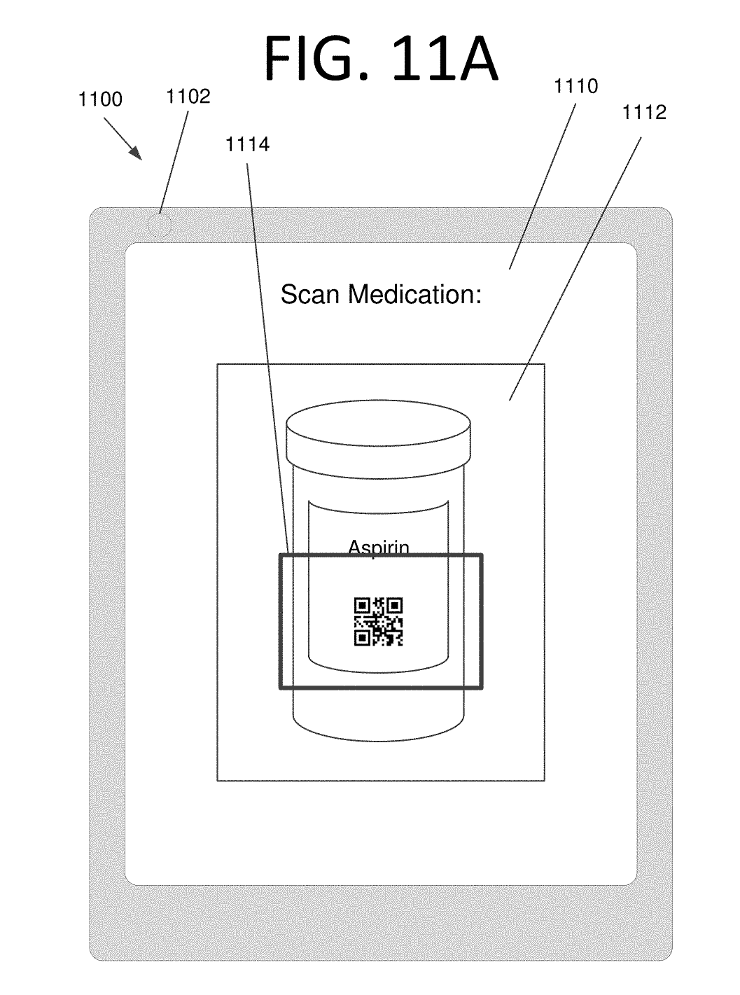

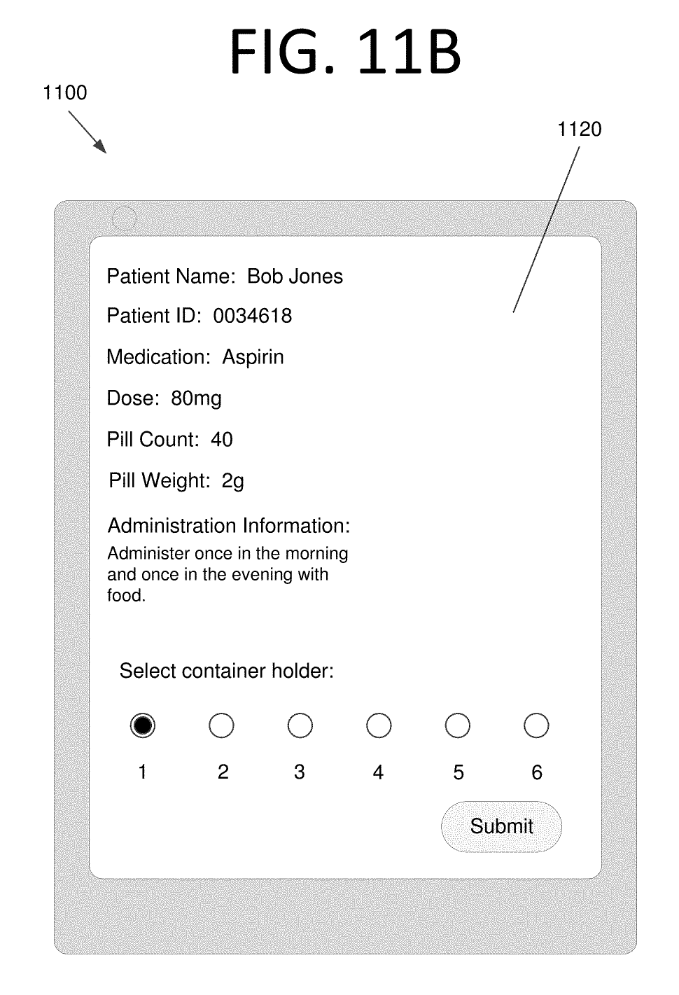

In some embodiments, a computing system, such as a tablet, a cell phone, etc. may be used to scan a medication and start medication monitoring using the medication management device of some embodiments. FIG. 11A illustrates a scanning screen 1110 on a tablet 1100, according to an embodiment of the present invention. A camera 1102 on the back of tablet 1100 enables the user to capture video of a pill bottle in scanning window 1112. A box 1114 indicates a region where tablet 1100 will attempt to read a QR code. In some embodiments, rather than having the user scan the label, an RFID tag may be automatically detected by tablet 1100.

Once the QR code is scanned (or the RFID tag has been detected), a container holder selection screen 1120 is shown. See FIG. 11B. Screen 1120 allows the user to view information pertaining to the scanned medicine container and select a container holder of the medication management device to store the specific medication container. In this embodiment, six container holders are included. In some embodiments, the user may not be able to select container holders that already contain medication, or the user may be able to clear a container holder and add a new medication container. Once the user clicks “submit”, the medication management device may verify when the medication container is placed in the appropriate container holder, issue an alarm if the container is in the wrong holder, receive information from tablet 1100 pertaining to the medication, start its own internal counter, and/or undertake any of the actions described herein without deviating from the scope of the invention.

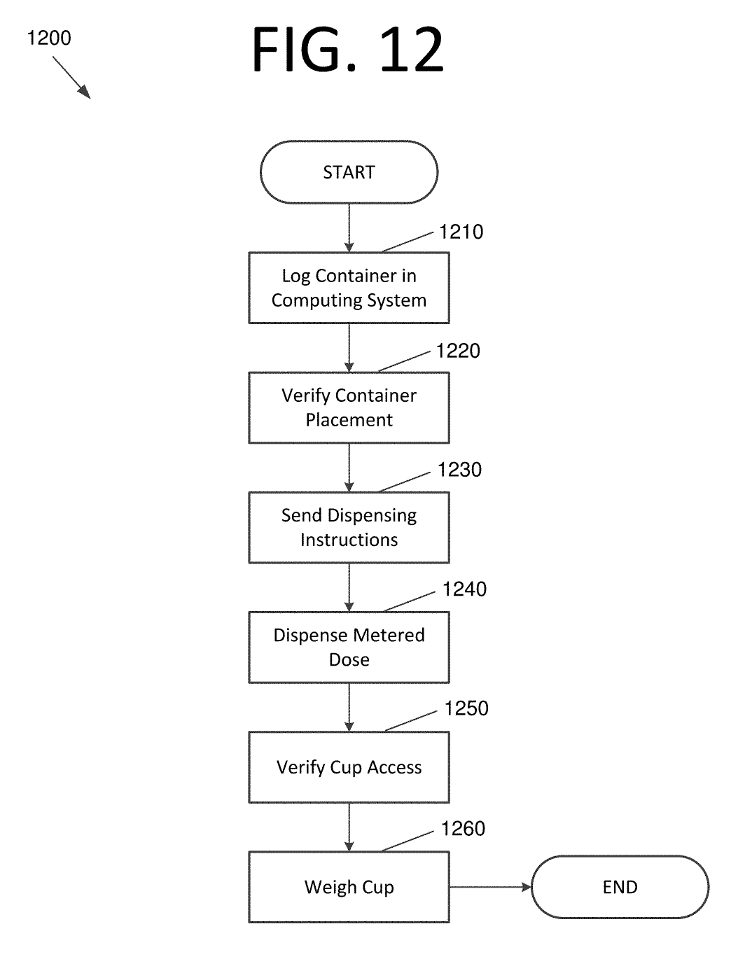

FIG. 12 is a flowchart 1200 illustrating a process for performing medication management, according to an embodiment of the present invention. The prescription container is logged into a computing system (e.g., a laptop, a cell phone, a tablet, etc.) at 1210. A medication management device then verifies that the medication was placed into an assigned compartment at 1220. If this was not the case, the user and/or other interested individuals may be notified accordingly. The prescription container may also be locked in the medication management device at this time.

When it is time to take a dose, the computing system sends instructions to the medication management device to dispense a dose of the medication at 1230. In certain embodiments, however, the medication management device itself may track dosing and perform notifications, and may issue an alert to take medication rather than actually dispensing a single dose. The medication management device then dispenses unit a metered dose into a cup at 1240. If multiple medicines are to be taken at the same time, multiple doses may be metered into the same cup in some embodiments. The medication management device may also verify that he correct quantity was metered via a scale and issue an alarm if this is not the case.

It is then verified that the user accessed the medicine cup at 1250. This can be done via a scale, a camera, a combination thereof, etc. Upon its return to the medication management device, the cup is weighed at 1260 to conform that the medication was taken.

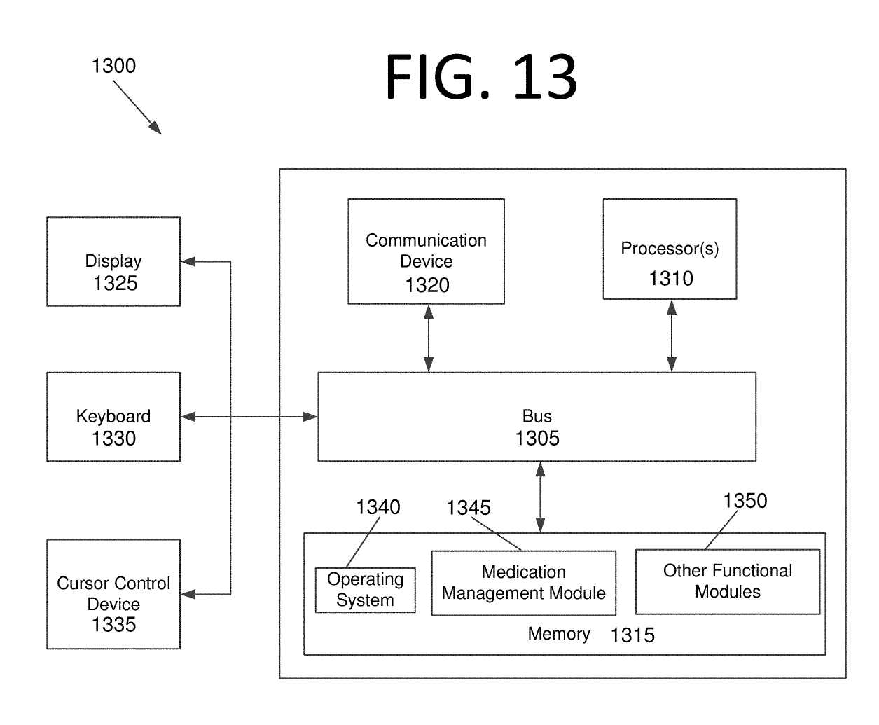

FIG. 13 illustrates a computing system 1300 configured to control and/or interact with a medication management device, according to an embodiment of the present invention. System 1300 includes a bus 1305 or other communication mechanism for communicating information, and processor(s) 1310 coupled to bus 1305 for processing information. Processor(s) 1310 may be any type of general or specific purpose processor, including a central processing unit (CPU) or application specific integrated circuit (ASIC). Processor(s) 1310 may also have multiple processing cores, and at least some of the cores may be configured for specific functions. System XX00 further includes a memory 1315 for storing information and instructions to be executed by processor(s) XX10. Memory 1315 can be comprised of any combination of random access memory (RAM), read only memory (ROM), flash memory, cache, static storage such as a magnetic or optical disk, or any other types of non-transitory computer-readable media or combinations thereof. Additionally, system 1300 includes a communication device 1320, such as a transceiver, to wirelessly provide access to a communications network.

Non-transitory computer-readable media may be any available media that can be accessed by processor(s) 1310 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 1310 are further coupled via bus 1305 to a display 1325, such as a Liquid Crystal Display (LCD), for displaying information to a user. A keyboard 1330 and a cursor control device 1335, such as a computer mouse, are further coupled to bus 1305 to enable a user to interface with system 1300. However, in certain embodiments such as those for mobile computing implementations, a physical keyboard and mouse may not be present, and the user may interact with the device solely through display 1325 and/or a touchpad (not shown). Any type and combination of input devices may be used as a matter of design choice.

In one embodiment, memory 1315 stores software modules that provide functionality when executed by processor(s) 1310. The modules include an operating system 1340 for system 1300. The modules further include a medication management module 1345 that is configured to configured to perform the various medication management processes via interaction with a medication management device and external computing systems discussed herein. System 1300 may include one or more additional functional modules 1350 that include additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIG. 12 may be performed by a computer program, encoding instructions for the nonlinear adaptive processor to perform at least the process described in FIG. 12, in accordance with embodiments of the present invention. The computer program may be embodied on a non-transitory computer-readable medium. The computer-readable medium may be, but is not limited to, a hard disk drive, a flash device, RAM, a tape, or any other such medium used to store data. The computer program may include encoded instructions for controlling the nonlinear adaptive processor to implement the process described in FIG. 12, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general-purpose computer, or an ASIC.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A system, comprising:
a medication management device configured to store and dispense multiple medications, the medication management device comprising:
memory storing computer program instructions that operate the medication management device,
at least one processor configured to execute the computer program instructions and control operation of electronic components of the medication management device,
a plurality of bins, each of the plurality of bins configured to store a respective medication,
a metering mechanism for each of the plurality of bins, each metering mechanism configured to dispense a medication of the respective bin,
a ramp or tube for each of the plurality of bins, each ramp or tube operably connected to a respective bin and configured to receive the dispensed medication from the respective bin, and
a dispenser base configured to receive the dispensed medication in a tray of the dispenser base, and/or to hold a cup that receives the dispensed medication.

2. The system of claim 1, wherein the computer program instructions are configured to cause the at least one processor to:
track a current time and a dosing schedule for each medication in each of the plurality of bins; and
dispense each medication in accordance with its respective dosing schedule.

3. The system of claim 1, wherein the dispenser base further comprises an electronic scale configured to weigh the dispensed medication.

4. The system of claim 2, wherein the computer program instructions are configured to cause the at least one processor to detect, via the electronic scale, whether a correct weight for one or more medications to be dispensed at a given time is present on the dispenser base.

5. The system of claim 4, wherein when the weight is too light, and insufficient medication has been dispensed, the computer program instructions are configured to cause the at least one processor to attempt to meter the medication again.

6. The system of claim 5, wherein when the correct weight of medication was not metered out after a predetermined number of attempts, the computer program instructions are configured to cause the at least one processor to issue an alarm to appropriate personnel and/or devices indicating that an error occurred and requesting action.

7. The system of claim 1, further comprising:
a locking lid, a medication access door, and/or a dose access door; and
a lock configured to lock the locking lid, the medication access door, or the dose access door.

8. The system of claim 7, wherein when the medication management device determines that the lock has been forced open, the computer program instructions are configured to cause the at least one processor to issue an alarm to appropriate personnel and/or devices informing them of the issue.

9. The system of claim 1, wherein the metering mechanism comprises a drum or a valve.

10. The system of claim 1, further comprising:
a control interface, communications hardware, a scanner, a power supply, or any combination thereof.

11. The system of claim 1, further comprising:
an external display configured to provide information pertaining to the dispensed medications.

12. The system of claim 1, further comprising:
a camera configured to begin recording when the user removes the medication and provide the recording to a caregiver or a healthcare professional.

13. The system of claim 1, further comprising:
a computing system configured to scan medications and provide medication information to the medication management device.

14. The system of claim 1, wherein the medication management device further comprises:
a light, a speaker, an oscillating motor, or any combination thereof, and the computer program is further configured to cause the at least one processor to provide an alert via the light, the speaker, and/or the oscillating motor indicating that it is time to take a medication.

15. The system of claim 1, wherein the program is configured to cause the at least one processor to issue an alert to a caregiver or medical professional if a dispensed medication is not taken for a predetermined period of time.

16. A medication management device, comprising:
a plurality of bins, each of the plurality of bins configured to store a respective medication;
a metering mechanism for each of the plurality of bins, each metering mechanism configured to dispense a medication of the respective bin;
a ramp or tube for each of the plurality of bins, each ramp or tube operably connected to a respective bin and configured to receive the dispensed medication from the respective bin; and
a dispenser base configured to receive the dispensed medication in a tray of the dispenser base, and/or to hold a cup that receives the dispensed medication.

17. The medication management device of claim 16, wherein the dispenser base further comprises an electronic scale configured to weigh the dispensed medication.

18. The medication management device of claim 16, further comprising:
a locking lid, a medication access door, and/or a dose access door; and
a lock configured to lock the locking lid, the medication access door, or the dose access door.

19. The medication management device of claim 16, further comprising:
a light, a speaker, an oscillating motor, or any combination thereof.

20. A medication management device, comprising:
a plurality of bins, each of the plurality of bins configured to store a respective medication;
a metering mechanism for each of the plurality of bins, each metering mechanism configured to dispense a medication of the respective bin;
a ramp or tube for each of the plurality of bins, each ramp or tube operably connected to a respective bin and configured to receive the dispensed medication from the respective bin;
a dispenser base configured to receive the dispensed medication in a tray of the dispenser base, and/or to hold a cup that receives the dispensed medication; and
a display configured to scan medications and provide medication information to the medication management device.
